(19) United States
(12) Patent Application Publication
(10) Pub. No.: US 2022/0042799 A1
(43) Pub. Date: Feb. 10, 2022

(54) Pilot car travel height sensor

(71) Applicant: Darin Tankersley, Catoosa, OK (US)

(72) Inventor: Darin Tankersley, Catoosa, OK (US)

(21) Appl. No.: 17/300,519

(22) Filed: Jul. 28, 2021

Related U.S. Application Data
(60) Provisional application No. 63/103,419, filed on Aug. 4, 2020.

(51) Int. Cl. G01C 5/00; B60Q 1/50; B60Q 9/00; G08G 1/095; G08G 1/16; G08G 1/0967

(52) U.S. Cl. CPC G01C 5/00; B60Q 1/50; G08G 1/096791; G08G 1/095; G08G 1/165; B60Q 9/00

(57) ABSTRACT

A travel height sensor is attached to a front of a pilot vehicle escorting a trailing vehicle hauling an oversized load to alert traffic ahead of the trailing vehicle of the oversized load approaching with the travel height sensor elevated to a highest point of the trailing vehicle and its oversized cargo, wherein the travel height sensor determines whether or not the trailing vehicle and cargo will clear a overhead wire, tree branch, bridge or overpass height prior to incurring damage to the trailing vehicle, its cargo or the overhead obstacle, the travel height sensor making contact with an obstruction below the preset height and subsequently communicating the contact to the driver of the pilot vehicle and driver of the trailing vehicle before the trailing vehicle arrives at the low obstruction, thus avoiding a catastrophic incident.

### CROSS REFERENCE TO RELATED APPLICATIONS

Applicant claims the benefit of Provisional Patent No. 63/103,419 filed by the same inventor on Aug. 4, 2020.

### I. BACKGROUND OF THE INVENTION

### 1. Field of Invention

A travel height sensor is attached to a front of a pilot vehicle escorting a trailing vehicle hauling an oversized load to alert traffic ahead of the trailing vehicle of the oversized load approaching with the travel height sensor elevated to a highest point of the trailing vehicle and its oversized cargo, wherein the travel height sensor determines whether or not the trailing vehicle and cargo will clear a overhead wire, tree branch, bridge or overpass height prior to incurring damage to the trailing vehicle, its cargo or the overhead obstacle, the travel height sensor making contact with an obstruction below the preset height and subsequently communicating the contact to the driver of the pilot vehicle and driver of the trailing vehicle before the trailing vehicle arrives at the low obstruction, thus avoiding a catastrophic incident.

### 2. Description of Prior Art

A preliminary review of prior art patents was conducted by the applicant which reveal prior art patents in a similar field or having similar use. However, the prior art inventions do not disclose the same or similar elements as the present pilot car sensor, nor do they present the material components in a manner contemplated or anticipated in the prior art. Those patents include U.S. Pat. No. 8,212,660 to Nugent and 3,269,783 to Kriz.

Nugent is a sensor mounting to a moving vehicle to measure the distance between an overhead obstacle ahead of the vehicle with a processor for determining a reference height above the ground level. The driver electronically programs the device to enter the height of the vehicle and the processor through a “means for determining a reference height” (distance between the ground and the obstacle). The sensor connects to a box which further connects to a power supply.

Kris mounts atop a truck and has on or more spring loaded antenna which extend to a height above the trailer towed behind the truck. It appears that when the antenna strikes a bridge, an alarm is sounded. However, based on FIG. 1, that would be a nearly instantaneous alarm which would sound as the antenna strikes the bridge, making it too late for the truck to avoid collision with the bridge of FIG. 1, if the truck were traveling faster than a mile per hour. Neither of these devices mount to a pilot car, nor attach to a simple extendable pole on the front of a pilot vehicle with a visual or audible warning signal to the oversized load vehicle of the impending contact in time to avoid the catastrophic contact between the oversize load and the obstruction present at a lower height than the oversized load.

It is known by those skilled in the art that stationary and rigid poles have been used in the past by pilot vehicles which are set at a height of the trailing load. When these are used, they merely hit the bridge or overhead obstruction and break or bend. The present travel height sensor is presented to be added to the top of these prior used extendable rigid poles to provide not only flexion to an upper contact sensor section, but present a local visible alert to the trailing vehicle and also an alternative audible alert being wirelessly sent to a remote receiver in the pilot vehicle and/or the trailing vehicle transporting the oversized load.

Other products on the market include on called the Giraffe G4, which retails for $249.95 on the Internet and a product called The RATTLER™, which sells for $189.00. Another product found, but having no record of sale, is called The OWL, which uses a 3-D LIDAR for detection. These devices present differing height sensing and alert means than the present claimed invention.

### II. SUMMARY OF THE INVENTION

The oversized load transportation industry presents unique problems with both the transport vehicle and the pilot vehicles which advance the transport vehicle and also trail the transport vehicle for traffic control purposes. The pilot vehicle prepares the way for the oversized load by alerting drivers traveling in the opposite direction that the oversized load is heading that way. Sometimes, prudence requires that the oncoming traffic move to the side or that they be aware that the oversized load may be approaching them for other driver aversion. A second function of the pilot vehicle is to escort the oversized load driver to avoid hazards ahead, including the presence of low height obstructions and mis-marked height restrictions. In order to do so, pilot cars have used fixed rigid poles on their vehicles which are set at a height equal to that of the oversized load hauled by the transport vehicle, as disclosed above. These are prior art devices that merely indicate a low height by striking the fixed rigid pole and bending or damaging it. Other height sensors are provided on the transport vehicle itself using complicated remote sensing means or momentary contact means which do not provide enough time to avoid impact at highway speeds.

The present travel height sensor is intended to be attached to these prior art fixed rigid poles to further assure clearance of the oversized load prior to arriving at the height restrictive object in the chosen transportation route by attaching to the top of the fixed rigid poles, placing an upper end of the travel height sensor at a height equal to that of the highest point of the oversized load being transported by the transport vehicle traveling behind the pilot vehicle. Upon contact of the upper end of the travel height sensor, multiple sensory alerts are sent to the driver of the pilot vehicle and also to the driver of the transport vehicle, using at least an LED indicator directed towards the drivers. This provides an awareness to the driver of the pilot vehicle, in constant communication with the transport driver, that an object in the pathway of the transport pathway may not be of sufficient height to clear the transport load prior to an accidental incident which could destroy not only the load, but the object in the pathway. These object include tree limbs, utility wires and bridges.

The present height sensing extension is attached to the adjustable height fixed rigid pole on the front bumper of the pilot vehicle which provides a contact sensor at the highest point of the travel height sensor which is wired to an electronic housing module. A contact signal is presented to a bright LED display visible to the drivers of the pilot and transport vehicles, with an optional wireless transmitter contemporaneously providing an audible and/or secondary visible indicator to a remote receiver in the pilot vehicle and/or the transport vehicle by wireless means. Numerous variations are possible with the height sensing extension.

### III. DESCRIPTION OF THE DRAWINGS

The following drawings are informal drawings submitted with this provisional patent application.

FIG. 1 is a front perspective view of the transport height sensor.

FIG. 2 is a rear perspective view of the transport height sensor.

FIG. 3 is a front view of the transport height sensor.

FIG. 4 is a rear view of the transport height sensor.

FIG. 5 is a side view of the transport height sensor.

FIG. 6 is a side sectional view of the transport height sensor with at least one remote receiver.

FIG. 7 is a sectional view of the transport height sensor along reference lines 7/7 of FIG. 3.

FIG. 8 is a sectional view of the transport height sensor along reference lines 8/8 of FIG. 3.

FIG. 9 is an expanded perspective view of the one embodiment of a pole connecting means at the lower end of the lower post section of the transport height sensor indicated in FIG. 3.

FIG. 10 is a diagram of a pilot vehicle in front of a transport vehicle whose oversized load has struck a bridge.

FIG. 11 is a diagram of the present transport height sensor mounted to a rigid fixed pole attached to the front of the pilot vehicle demonstrating the manner in which the transport height sensor enables the transport vehicle to avoid having its oversized load strike the upcoming bridge.

### IV. DESCRIPTION OF THE PREFERRED EMBODIMENT

The height sensing extension is purposed for the oversized load industry which uses pilot vehicles A and transport vehicles M to haul oversized loads N. The purpose for the pilot vehicles in to enhance safety for the pilot vehicle operator and the general public and also increases the response time for the transport vehicle operator to slow down to avoid the low obstructions ahead. This is illustrated in FIG. 11, where the potential failure of the current art is exposed and illustrated, demonstrating a bridge X strike by the oversized load N.

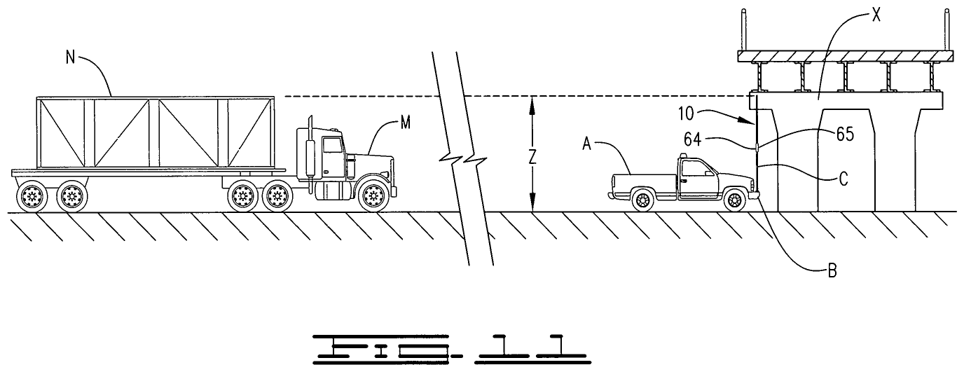

Currently, the industry uses CB to communicate between the operators of the transport vehicle and pilot vehicle. These operators can lose communication in poor radio traffic conditions, using poor equipment or distance between the two. When an oversized load N hits an overhead obstruction X, as shown in FIG. 10 of the drawings, damages are costly and travel is inhibited for long periods of time during cleanup or repair. When an overhead power line is struck, it can cause costly power outages, fire and even death to the driver of the transport vehicle M. Low hanging branches and tress can damage not only the tree, but the oversized load N, even displacing the load from its travel restraints.

Pilot vehicle operators have several duties while operating the pilot vehicle A. They are called upon to multi-task, including watching for turns on routes that are permitted by Federal, State and local authorities, having reduced visibility due to sun, low-light conditions and weather, constantly scanning for other vehicles and road risk hazards including shoulder obstructions, pedestrians, animals, and other low level obstructions while still observing overhead issues, as well as full time communications and phone calls. In the past, some pilot vehicles A have used extendable height poles C to provide a means to determine the height of the transport pathway along highways which they attach to the front bumper B of the pilot vehicle A. When the top of this extendable pole C strikes an object, the pilot driver communicates with the transport vehicle M to let them know of the pole strike. This requires a visual observation, a determination of the hazard, a communication between the pilot vehicle driver and the transport vehicle driver, and ultimately a remedial action by the transport driver. A missed step in this multiple step process can result in late notification or a failed notification. The prior alert and current passive height sensing extension provides a less efficient and non-failsafe means of monitoring height obstructions.

The present travel height sensor 10, attached above the present extendable pole C on the pilot vehicle A reduces human errors, maximizes safety, reduces delayed communication and safety is greatly enhanced. It is contemplated that the travel height sensor 10 and the extendable pole C could be combined into a unitized device, mounting to the front bumper B of the pilot vehicle with an adjustable height section, not shown. Using the present active travel height sensor with directionally visible LED lighting and/or remote notifications, the travel height sensor 10 attached to a prior art adjustable height pole C can be seen for up to ½ mile. This active alert allows the operator of the transport vehicle M an opportunity to slow down after the travel height sensor 10 on the leading pilot vehicle A is activated due to a “hit” on the low height obstruction ahead.

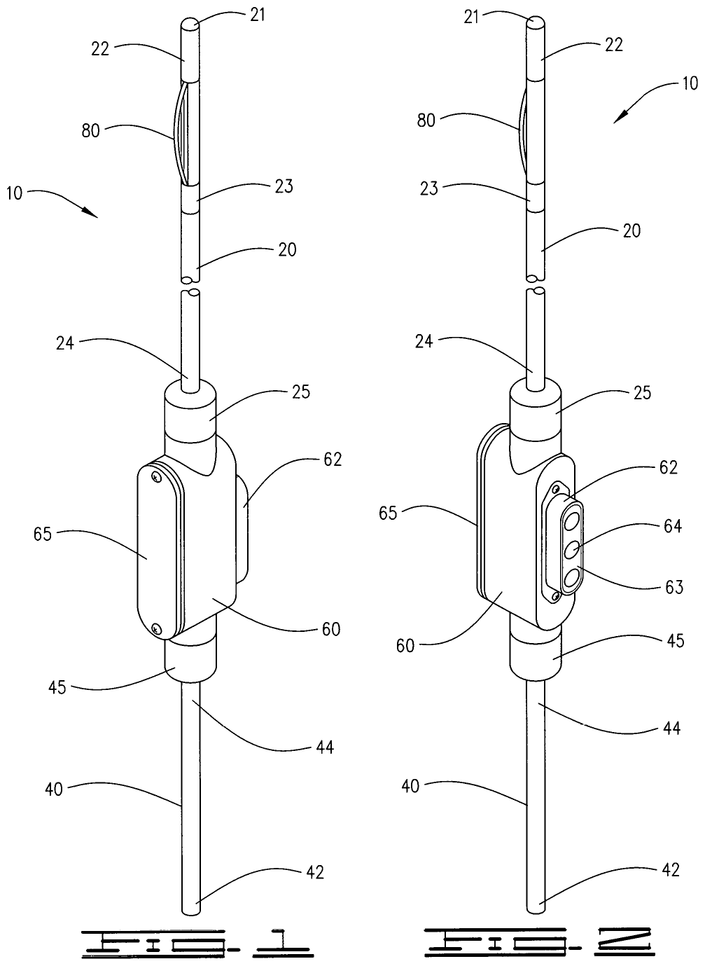

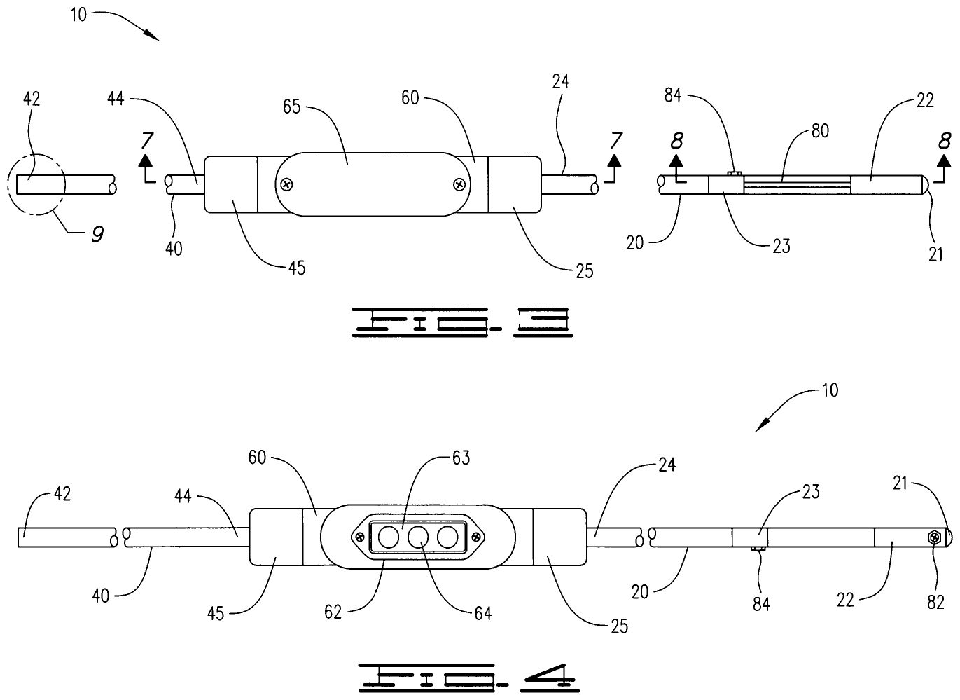

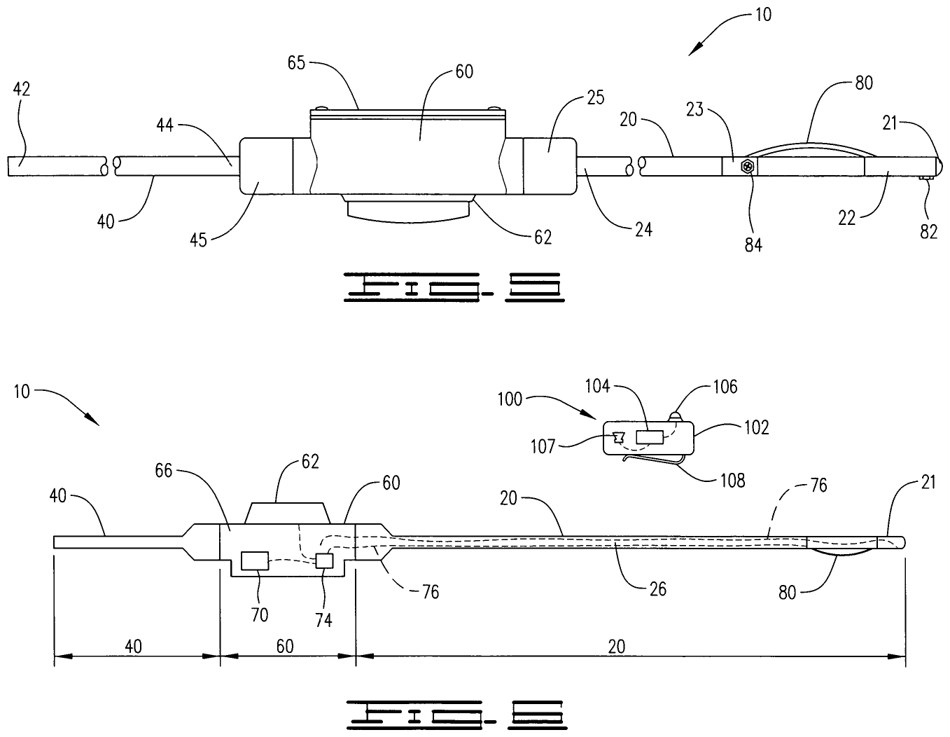

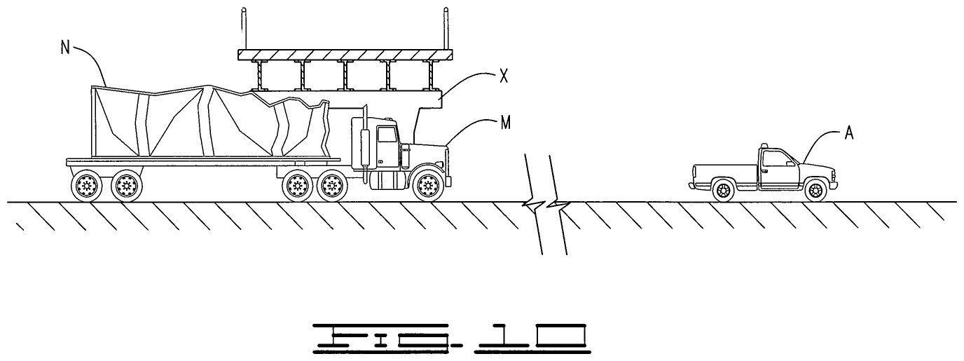

In this regard, a travel height sensor 10 is an active height sensing device mounted to an extendable pole C attached to a front bumper B of a pilot vehicle A which is extended to a highest height Z of an oversized load N of a transport vehicle M, as shown in FIG. 11. It provides an active visual alert and an optional audible alert which is indicated by the strike of the travel height sensor with an obstruction which is below the highest height Z of the oversized load N. The travel height sensor 10, shown in FIGS. 1-9 and 11, comprises an upper post section 20, a lower post section 40, an electronic housing module 60 having a control processor 74 activating at least one LED 64 and an optional remote transmitter 70 in communication with a remote receiver 100 which includes a second remote receiver LED 106 and an audio speaker 107 which generates an audible alert.

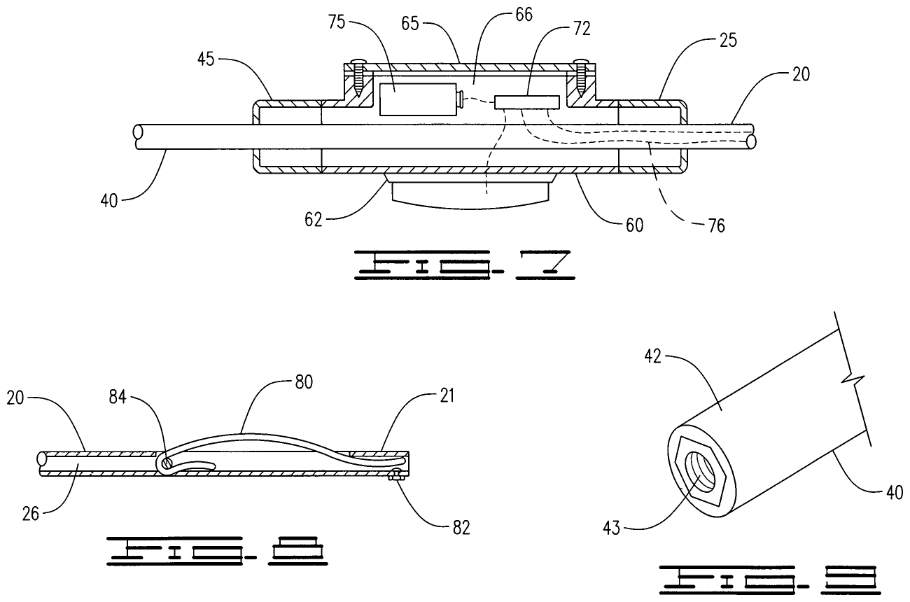

The travel height sensor 10, in FIGS. 1-7, further defines the upper post section 20 with an upper end 21 covered by a protective cap 22, a lower protection sleeve 23, a lower end 24 attached to an upper housing segment 25 attached to the electronic housing module 60, and an inner channel 26. Installed between the protective cap 22 and the lower protection sleeve 23 is an exposed impact switch coil 80 attached by electrical wiring 76, anchored within the inner channel 26 by a coil anchor pin 84, FIG. 6. The electrical wiring 76 connects the impact coil switch 80 to the control processor 74 within the module cavity of the electronic housing module 60. When the exposed impact coil switch 80 is struck, the exposed impact coil 80 is moved to make contact with a grounded threaded screw nut 82 which completes a DC circuit signaling that the impact coil 80 has made contact with an obstruction, causing the control processor 74 to be sent an electronic momentary interrupt signal programmed as a contact alert indicator. This impact switch coil 80 senses the contract strike at the upper end 21 of the upper post section 20 which has been set at a height equal to the highest point Z of the oversized load N, FIG. 11.

For purpose of the travel height sensor 10, the control processor 74 is a programmable computer processor, including an Ardueno® processor or other substantial equivalent, which may be programmed to perform numerous tasks and generate multiple task signal to multiple respective devices, including LED lights, audio speakers, transmitters and receivers simultaneously. It operates on a low voltage local power supply 75 and connects to the various devices by wire or through wireless signal technology.

The lower post section 40, in FIGS. 1-9, further comprises a lower end 42 defining an extendable pole connecting means 43 and an upper end 44 with a lower housing segment 45 attached to the electronic housing module 60. The extendable pole connecting means 43 attaches to the extendable pole C, FIG. 11. As shown in FIG. 9, the extendable pole connecting means 43 is an inner thread, but this may be any other means which allows for the connection of the lower post section 40 to a pole C, including a set screw, a dual open ended sleeve or even strong adhesive tape.

The electronic housing module 60 defines the module cavity 66, a light base 62 containing a linear light plate 63 with the at least one LED 64, and a removable rear access plate 65 which forms a weather proof seal into the module cavity 66. Within the module cavity 60 is anchored the control processor 74 in communication with the impact switch coil 80 by the electrical wiring 76 traveling through the inner channel 26 of the upper post section 20, the control processor 74 further attaching by electrical wiring 76 to an LED relay 72 which connects to the at least one LED 64, causing the at least one LED 64 to illuminate when the impact switch coil 80 is struck. The control processor is powered by a low voltage battery 75, also contained within the module cavity 66. In the event the remote receiver 100 is included with the travel height sensor 20, a remote transmitter 70 is also wired to the control processor 74 within the module cavity 60 which generates a wireless signal to the remote receiver 100 as prompted to do so by the control processor 74. It is contemplated that communication between the control module 74 and the remote receiver 100 could also be by hardwire.

The remote receiver 100 defines a case 102 with an attaching means 108 for mounting within the pilot and/or transport vehicles A, M, a receiver control module 104 that receives the wireless signal from the remote transmitter 70 which causes the receiver control module 104 to activate at least one receiver LED 106 installed within the case 102 and/or an audio speaker 107 which generates an audible alert, creating an audio/visual alert to the driver of the pilot vehicle A and/or the driver of the transport vehicle M, thus providing an nearly instantaneous warning to either or both drivers of an overhead hazard triggered by an impact to the impact switch coil 80 to the upper end 21 of the upper post section 20. The transport vehicle M, if traveling at a rate of assured stopping distance behind the pilot vehicle A would therefore be provided ample opportunity to avoid the catastrophic damage as illustrated in FIG. 10, shown by the oversized load having struck a bridge X.

Although the embodiments of the travel height sensor 10 have been described and shown above, it will be appreciated by those skilled in the art that numerous modifications may be made therein without departing from the scope of the invention as herein described.

I claim:

1. A travel height sensor attached atop an adjustable height pole mounted to a front bumper of a pilot vehicle providing escort to a transport vehicle carrying an oversized load, said travel height sensor comprising:
an upper post section defining an upper end with a protective cap, a lower protection sleeve, an impact coil switch outwardly exposed between said protective cap and said lower protection sleeve, an inner channel and a lower end securing an upper housing segment;
a lower post section defining a lower end having an extendable pole connecting means, and an upper end securing a lower housing section;
an electronic housing module attaching said lower housing section and said upper housing section, said electronic housing module defining a light base attaching a linear light plate with at least one LED, a removable rear access panel and containing a module cavity, within which is places a low voltage battery, a control processor, an LED relay, all attached by electronic wiring, wherein said impact switch coil is further hingedly anchored within said inner channel at said upper end of said upper post section by a coil anchor pin within said inner channel with a threaded screw nut within said inner channel upon said protective cap making contact with said impact coil switch upon impact with a low height structure, sending a signal through electrical wiring to said control processor, transmitting a signal to said LED relay causing said at least one LED in linear light plate to illuminate, providing a visible signal to a driver of said pilot vehicle and driver of said trailing transport vehicle that a low height impact has occurred due to an overhead object strike which has occurred to said travel height sensor which has been set to a height equal to that of the highest point of the oversized load being transported by said transport vehicle prior to travel.

2. The travel height sensor of claim 1, further comprising:
a remote transmitter wired to said control processor within said module cavity of said electronic housing module which emits an additional wireless or wired signal upon contact strike by said impact switch coil;
a remote receiver defining a case within which is provided a receiver control module which receives said wireless or wired signal and processes said signal to illuminate an additional LED within said case, and produce an audible sound through a connected audio speaker within said case, wherein said remote receiver is installed within said pilot vehicle and/or said transport vehicle, depending upon the number of remote receivers provided, by an attaching means providing an additional visible and audible alert to the respective drivers of a contact strike by said travel height sensor.

3. The travel height sensor of claim 1 further comprising any other feature as disclosed in said specification or drawings attached hereto.
